(19) United States
(12) Patent Application Publication
(10) Pub. No.: US 2025/0307678 A1
(43) Pub. Date: Oct. 2, 2025

(54) System and method of loading classical data into a quantum processor via an adaptive hardware-aware state preparation using iterative tensor-decompositions and quantum circuit generation

(71) Applicant: data cybernetics ssc GmbH, Landsberg am Lech (DE)

(72) Inventors: Carsten Blank, Landsberg am Lech (DE); Israel Ferraz de Araujo, Recife - PE (BR)

(21) Appl. No.: 19/075,065

(22) Filed: Mar. 10, 2025

Related U.S. Application Data
(60) Provisional application No. 63/564,484, filed on Mar. 12, 2024.

(51) Int. Cl. G06N 10/20; G06N 10/40

(52) U.S. Cl. CPC G06N 10/20; G06N 10/40

(57) ABSTRACT

A system and method for encoding classical data into an executable quantum state with n executable d-level qudits (including two-level qubits; d=2) designed for a quantum processor. The classical data in the form of an N-dimensional complex-valued vector (N=dⁿ) is received and loaded by a loading device onto qudits that are in a known initial state. The classical data is initialized as a dⁿ-dimensional complex-valued and normalized data vector to obtain initialized data representing the n executable qudits state. A representation of the initialized data is found via the Tucker tensor decomposition using a tensor G and unitary operators while minimizing a decomposition performance measure. Further, the representation is translated into a quantum gate set to be applied to the initial quantum circuit to obtain a prepared quantum circuit while a state approximation performance measure of the executable quantum state is minimized. The method is hardware-aware and iterative, where the representation search is guided by the performance measures.

### CROSS-REFERENCE TO RELATED APPLICATIONS

This application claims priority from U.S. Provisional Patent Application No. 63/564,484 filed on Mar. 12, 2024 and which is incorporated herein by reference for all purposes in its entirety.

### FIELD OF THE INVENTION

The present invention relates to the field of quantum computing, and more specifically to a system and a method for loading classical data into a quantum processor in a manner that is hardware-aware and deploys an iterative tensor-decomposition process that uses Tucker tensor representation in generating a quantum circuit whose performance measure guides the iteration process.

### BACKGROUND OF THE INVENTION

Quantum computing is a promising field that has seen many recent technological advances. Presently, quantum computing hardware is considered to be in an era of noisy intermediate-scale quantum (NISQ) devices. Such devices, as the name implies, face many engineering and deployment challenges. Specifically, NISQ devices contend with low fault-tolerance requiring quantum error correction and face many other issues related to quantum circuit hardware that implements quantum gates. Furthermore, challenges arise in encoding data into quantum circuits and loading these into the quantum mechanical states of the corresponding quantum processing unit (QPU) for execution. This problem is known as the quantum state preparation or data encoding and loading problem. To understand the issues, it is necessary to first review quantum bits, commonly referred to as qubits by those skilled in the art, which are the fundamental building blocks of quantum computation.

FIG. 1A shows a single-qubit state |0 [symbol] that corresponds to the classical bit 0. State |0 [symbol] is expressed in the well-known Dirac notation as a ket vector. More specifically, single-qubit state |0 [symbol] is represented in the computational basis as a column vector [1, 0]^{T} (where subscript T denotes transpose) and is visualized using a Bloch sphere 10A. In this representation, state |0 [symbol] corresponds to a unit vector (unit length) pointing upward along the Z-axis of Bloch sphere 10A, terminating at point 12A on its surface. FIG. 1B illustrates a single-qubit state |1 [symbol] that corresponds to the classical bit 1. In the computational basis, state |1 [symbol] is represented by a column vector [0,1]^{T} and visualized with a Bloch sphere 10B. State |1 [symbol] corresponds to a unit vector pointing downward along the Z-axis of Bloch sphere 10B, terminating at point 12B on its surface.

Bloch spheres 10A, 10B are unit spheres parameterized by the X, Y and Z axes. Any vector extending form the center to the surface of these unit spheres has unit length. In the Bloch sphere representation, the Y-axis is imaginary-valued by convention, as it reflects the imaginary components of a qubit's state. This arises from the fact that the two entries of a qubit's column vector are generally complex-valued. In other words, qubits represented by states |0 [symbol] and |1 [symbol] , as well as any other qubit states, inhabit a two-dimensional complex space [symbol] . This renders them fundamentally distinct from classical bits, as explained below.

FIG. 1C illustrates a qubit that has no classical bit analogue. In fact, single-qubit state |ψ [symbol] is somewhere between a classical 0 bit and a classical 1 bit. In this visualization, state |ψ [symbol] extends from the center to a point 12C on the surface of Bloch sphere 10c. In the Bloch sphere representation, state |v [symbol] is described by angles θ, φ. Note that, like the previously discussed states |0 [symbol] and |1 [symbol] , state |ψ [symbol] also has unit length.

From the fact that the Y-axis is imaginary-valued, it is immediately apparent that two complex numbers, c₁ and c₂, are required to specify single-qubit state |ψ [symbol] as the column vector [c₁, c₂]^{T}. FIG. 1C illustrates how state |ψ [symbol] is decomposed in the [1, 0]^{T}, [0, 1]^{T} basis (the basis defined by states |0 [symbol] and |1 [symbol] ), where the two complex numbers c₁ and c₂ are the coefficients multiplying the respective basis vectors. This type of decomposition, using orthonormal basis vectors, is standard in the art.

Although Bloch sphere 10C is useful for visualization, care should be taken when relying on it to form intuitions about single-qubit state |ψ [symbol] . That is because state |ψ [symbol] residing in two-dimensional complex space [symbol] , double-covers the Bloch representation. This arises from the fact that state |ψ [symbol] is described by two complex numbers, c₁ and c₂, each of which has a real part and an imaginary part. Plotting a single complex number requires a real axis and an imaginary axis. Hence, four (4) axes are required to fully represent c₁ and c₂. Meanwhile, Bloch sphere 10C has only three axes (X, Y, Z), with just one of them (Y) being imaginary-valued. Thus, it becomes clear that actual state |ψ [symbol] is a double cover of the Bloch representation. Many crucial aspects of physical qubits are due to their higher dimensionality. (For a more in-depth understanding of the possibilities afforded by the extra imaginary-valued dimension beyond those shown in the Bloch representation, the diligent reader is referred to standard teachings on spinors and twistors.)

FIG. 1C summarizes the properties of any single-qubit state (number of qubits n=1) represented in the Dirac notation as |ψ [symbol] . Specifically, any single-qubit state resides in a two-dimensional complex space [symbol] , which, in this context, is the Hilbert space [symbol] _{C}. The number of dimensions N required to represent a single-qubit state (n=1) is explicitly indicated as N=2. Importantly, it is also noted that as the number of qubits n increases, the number of complex dimensions N required to represent the resulting state grows exponentially as 2ⁿ, since each additional qubit doubles the number of coefficients required to specify the state.

FIG. 1D presents a scenario where the number of qubits is 2 (n=2). Specifically, a single-qubit state |ψ [symbol] _{A}, residing in its Hilbert space [symbol] _{A}, is shown on the left, while another single-qubit state |ψ [symbol] _{B}, residing in its Hilbert space [symbol] _{B}, is shown on the right. As before, states |ψ [symbol] _{A}, |ψ [symbol] _{B} are visualized in their corresponding Bloch spheres 10A, 10B as ket vectors decomposed over the basis |0 [symbol] , |1 [symbol] . The complex coefficients of state |ψ [symbol] _{A} in the |0 [symbol] , |1 [symbol] basis are c₁^{A}, c₂^{A}, respectively. Similarly, the complex coefficients of qubit |ψ [symbol] _{B} in the |0 [symbol] , |1 [symbol] basis are c₁^{B}, c₂^{B}, respectively.

In the case shown in FIG. 1D, single-qubit states |ψ [symbol] _{A}, |ψ [symbol] _{B} do not affect each other. Such separate and non-interacting states are not entangled with one another. Their separate, unentangled condition is symbolically indicated by a partition symbol 14 positioned between them.

Unentangled qubits are straightforward to handle because their joint state is separable or factorizable. This becomes evident through the construction of a tensor product state |ψ [symbol] _{AB} from states |ψ [symbol] _{A}, |ψ [symbol] _{B}. Specifically, in producing tensor product |ψ [symbol] _{AB}, single-qubit states |ψ [symbol] _{A}, |ψ [symbol] _{B} are combined, as shown in FIG. 1D, to yield |ψ [symbol] _{AB}=|ψ [symbol] _{A}⊗|ψ [symbol] _{B}. The tensor products of the basis vectors |0 [symbol] and |1 [symbol] result in four tensor basis states: |00 [symbol] , |01 [symbol] , |10 [symbol] and |11 [symbol] over which tensor product state |ψ [symbol] _{AB} is conveniently decomposed. During the tensorization of |ψ [symbol] _{A} and |ψ [symbol] _{B} their respective complex coefficients c₁^{A}, c₁^{A} and c₁^{B}, c₂^{B} combine to form the joint complex coefficients c₁^{A}c₁^{B}, c₁^{A}c₂^{B}, c₂^{A}c₁^{B}, c₂^{A}c₂^{B} that multiply the tensor basis states |00 [symbol] , |01 [symbol] , |10 [symbol] , |11 [symbol] , respectively.

FIG. 1D shows the general representation of tensor product state |ψ [symbol] AB in summation form as follows:

$${{{\vert ψ 〉}_{AB} = {\sum }_{i , j} {c}_{ij} \vert i 〉}_{A} ⊗ \vert j 〉}_{B} \qquad Eq . 1$$

where i=1, 2 and j=1, 2, the cᵢⱼ's are the joint complex coefficients for the corresponding four tensor basis states |i [symbol] _{A}⊗|j [symbol] _{B} (note that according to some conventions the indices run over 0,1). Despite being unentangled, states |ψ [symbol] _{A} and |ψ [symbol] _{B} can clearly be used to express a tensor product |ψ [symbol] _{AB} of the general form shown in Eq. 1. However, that general form can be separated or factorized to recover the respective complex coefficients c₁^{A}, c₂^{A} and c₁^{B}, c₂^{B} of individual states |ψ [symbol] _{A} and |ψ [symbol] _{B}. That is because the tensorization operation is reversible in the case of unentangled states such as states |ψ [symbol] _{A} and |ψ [symbol] B. Since the joint complex coefficients cᵢⱼ's are obtained through simple multiplication of the respective complex coefficients c₁^{A}, c₂^{A}, c₁^{B} and c₂^{B}, the individual states |ψ [symbol] _{A}, |ψ [symbol] _{B} can be easily recovered. Thus, in the case of tensor product |ψ [symbol] _{AB}=|ψ [symbol] _{A}⊗ψ [symbol] _{B} of unentangled states, the original states remain accessible.

In stark contrast, FIG. 1E illustrates a case where a tensor product |ψ [symbol] _{AB} of two single-qubit states |ψ [symbol] _{A} and |ψ [symbol] _{B} is not factorizable. In other words, states |ψ [symbol] _{A} and |ψ [symbol] _{B} are not separable, as their joint state cannot be expressed simply as a tensor product of their individual states |ψ [symbol] _{AB}≠|ψ [symbol] _{A}⊗|ψ [symbol] _{B}; they are entangled. It is important to understand that entanglement cannot be produced locally. Differently put, entanglement cannot be generated by operating on a single qubit in isolation from the other qubit with which entanglement is sought. Physically, quantum entanglement is created through interaction (i.e., a symmetry preserving interaction).

Correspondingly, FIG. 1E shows single-qubit states |ψ [symbol] _{A} and |ψ [symbol] _{B} in Bloch representation, as before, but this time they are not separated. Instead, they interact, as indicated by interaction symbol 16. Through this interaction, they form an entangled state |ψ [symbol] _{AB} that resides in their joint Hilbert space. This joint space is a tensor product space of their individual Hilbert spaces, namely [symbol] _{AB}= [symbol] _{A}⊗ [symbol] _{B}. The general representation of tensor product state of Eq. 1 still applies. However, the joint complex coefficients c₁₁, c₁₂, c₂₁, c₂₂ that multiply the tensor basis states |00 [symbol] , |01 [symbol] , |10 [symbol] , |11 [symbol] can no longer be decomposed and assigned to individual states |ψ [symbol] _{A} and |ψ [symbol] _{B} as before. To elaborate, in the case of a factorizable unentangled state, the coefficients would satisfy the relationships c₁₁=c₁^{A}c₁^{B}, c₁₂=c₁^{A}c₂^{B}, c₂₁=c₂^{A}c₁^{B}, c₂₂=c₂^{A}c₂^{B}. For the entangled state, however, such a factorization is no longer possible.

There are four maximally entangled two-qubit states, also called the Bell states. These states are as follows:

$${\vert {ϕ}^{\pm } 〉}_{AB} = \frac{1}{\sqrt{2}} ( \vert 00 〉 \pm \vert 11 〉 ) , \qquad Eq . 2 a$$

$${\vert {ψ}^{\pm } 〉}_{AB} = \frac{1}{\sqrt{2}} ( \vert 01 〉 \pm \vert 10 〉 ) . \qquad Eq . 2 b$$

In Eqs. 2a, the joint complex coefficients are c₁₁=c₂₂=1/\sqrt{2}, and the entanglement describes symmetric states (e.g., those physically associated with bosons). In contrast, in Eqs. 2b, the coefficients are c₁₂=c₂₁=1/\sqrt{2}, and the entanglement describes antisymmetric states (e.g., those physically associated with fermions). In the field of quantum computing, Bell states can be produced by quantum circuits utilizing quantum gate sets that include a Hadamard gate and a CNOT gate. Such quantum gates are known to those skilled in the art.

The Bloch representation visualizes maximal entanglement of qubits by positioning points 12A and 12B at the center of Bloch spheres 10A and 10B, as shown in FIG. 1E. Naturally, the degree of entanglement can vary, ranging from maximal to low. For less entangled qubits, points 12A and 12B are positioned closer to the surfaces of Bloch spheres 10A and 10B. The diligent reader will note that the ability to entangle two qubits in four distinct ways under symmetric and antisymmetric statistics (the antisymmetric statistics famously including the singlet state |ψ⁻ [symbol] _{AB}, characteristic of fermions such as electrons), arises from the additional imaginary-valued dimension, which cannot be represented in the three-dimensional Bloch sphere visualization.

The field of quantum computing has long recognized entanglement as a resource unavailable in classical computing. However, entanglement, like other quantum features such as superposition of quantum states, can still be modeled by a classical computer. In fact, preparing an n-qubit state |Ψ [symbol] (consisting of n of qubits |ψ [symbol] ₁, |ψ [symbol] ₂, . . . , |ψ [symbol] ₙ yielding N=2ⁿ dimensions) for execution by a corresponding quantum gate set on the present-day NISQ devices or quantum processing units (QPUs) relies on classical computing. Specifically, part of the computations required to derive full state |Ψ [symbol] is performed by a Central Processing Unit (CPU) or other classical computing resources, such as a Graphics Processing Unit (GPU).

Offloading of computations to the CPU for an arbitrary state vector |Ψ [symbol] , as often required in quantum machine learning and data processing, is a formidable task. It is well recognized in the art that separating full state |Ψ [symbol] into low-entangled subsystems, even if the procedure is only approximate, is highly desirable. Approximating full state |Ψ [symbol] offers the advantage of reducing the depth of the quantum circuit and may, in practice, achieve higher fidelity than exact initialization. Consequently, efficiently determining entanglement levels is a critical procedure in the field of quantum computing.

FIG. 1F illustrates a typical prior art method for determining the level of entanglement between single-qubit states |ψ [symbol] _{A} and |ψ [symbol] _{B}. Again, single-qubit states |ψ [symbol] _{A}, |ψ [symbol] _{B} are depicted using Bloch spheres 10A and 10B. In this example, the entanglement is not maximal; therefore, points 12A and 12B are not located at the centers of Bloch spheres 10A and 10B but rather closer to their surfaces. It is worth noting that entanglement is not the only reason why points 12A and 12B would retreat from the surfaces of their Bloch spheres. A quantum state that is itself a superposition of two or more different quantum states (i.e., a state that is not pure) will exhibit similar behavior. Indeed, quantum states in nature are typically not pure; they are commonly referred to as mixed states by skilled artisans. Given that pure states are rare, it is often more practical to represent a quantum state using a density matrix rather than a state vector.

The prior art teaches application of the Schmidt decomposition on joint state |ψ [symbol] _{AB} to determine the level of entanglement between subsystems A and B. (It is worth noting, that if the system is already in a pure quantum state, then its von Neumann entropy is zero and the system itself has no entropy to reduce. However, when considering subsystem entropy, swapping qubits can redistribute entanglement and effectively lower the entropy of certain subsystems). Schmidt decomposition is derived from Singular Value Decomposition (SVD) and assumes that joint state |ψ [symbol] _{AB} resides in the tensor space of the two Hilbert spaces, i.e., |ψ [symbol] _{AB}∈ [symbol] _{A}⊗ [symbol] _{B}. Hilbert spaces [symbol] _{A} and [symbol] _{B} are described by corresponding orthonormal sets of vectors {v₁, v₂, . . . , vᵣ} and {w₁, w₂, . . . , wᵣ}, respectively. The dimensionality of Hilbert spaces [symbol] _{A} and [symbol] _{B} can be more than two (denoted as d in this example). Furthermore, the orthonormal sets of vectors parameterizing [symbol] _{A} and [symbol] _{B} do not necessarily need to be basis vectors. Under these conditions, the Schmidt decomposition of joint state |ψ [symbol] _{AB} is expressed as:

$${\vert ψ 〉}_{AB} = {\sum }_{k}^{r} {μ}_{k} \vert {v}_{k} 〉 ⊗ \vert {w}_{k} 〉 = {\sum }_{k}^{r} \sqrt{{λ}_{k}} \vert {v}_{k} 〉 ⊗ \vert {\tilde{w}}_{k} 〉 , \qquad Eq . 3$$

where the coefficients μₖ's are real and positive numbers. The second expression restates the decomposition, explicitly identifying λₖ's as the Schmidt coefficients. In the Schmidt decomposition, r represents the degree of entanglement and the number of (non-zero) k's is referred to as the Schmidt rank. The condition in which k=1, and r is also 1, indicates that the state is not entangled, and the Schmidt rank is 1. For k>1, the state is entangled. If k=r and all coefficients μₖ's (or equivalently λₖ's) are equal, the state is maximally entangled. Note that the Schmidt coefficients, when different from each other, are ordered from the largest to the smallest. To efficiently apply the Schmidt decomposition, the states or qubits must be presented in tensorized form rather than vector form, as mentioned above.

FIG. 1G illustrates the step of tensorizing the unentangled state |ψ [symbol] _{AB}=|ω [symbol] _{A}⊗|ψ [symbol] _{B} from FIG. 1D. Vector states |ψ [symbol] _{A} and |ψ [symbol] _{B} are first tensorized (to express them as a tensor product of two inner product spaces, i.e., [symbol] _{A}⊗ [symbol] _{B}). The tensorization operation is explicitly depicted in FIG. 1G to clarify the formation of the product of spaces [symbol] _{A} and [symbol] _{B}, which occupies the complex space [symbol] . Note that the column vector representation of |ψ [symbol] _{A} resides in [symbol] , while the row vector representation of |ψ [symbol] _{B} expressed as |ψ [symbol] _{B}^{T} (where T denotes the transpose) resides in [symbol] . A person skilled in the art will recognize that many notation conventions exist and that a row vector can alternatively be expressed using a bra vector in Dirac notation.

FIG. 1G further shows how the Singular Value Decomposition (SVD), is applied to the tensorized state |ψ [symbol] _{AB}. Recall here that the Schmidt decomposition is essentially the SVD for bipartite quantum systems (two-part systems). In this example, the SVD decomposition contains only one singular value, located in the upper-left entry of singular value matrix Σ (analogous to the Schmidt coefficient matrix), and this value is equal to 1. This result is unsurprising, as state |ψ [symbol] _{AB} Was originally obtained by simple tensor multiplication of states |ψ [symbol] _{A} and |ψ [symbol] _{B} (see FIG. 1D and the corresponding description). In other words, state |ψ [symbol] _{AB} is known to factorize, as it is not entangled. Clearly, the SVD provides a convenient way to represent the unentangled state and immediately reveals why it has rank one in both the SVD and Schmidt decomposition.

FIG. 1H, in contrast, illustrates the application of the SVD to the maximally entangled state |ψ [symbol] _{AB}≠|ψ [symbol] _{A}⊗|ψ [symbol] _{B}, as previously introduced in FIG. 1E and its corresponding description. In this case, singular value matrix Σ contains two equal diagonal entries of ½, and the Schmidt rank is 2. This confirms that state |ψ [symbol] _{AB}≠ψ [symbol] _{A}|ψ [symbol] _{B} is maximally entangled. It is worth noting that while the SVD is highly effective for analyzing entanglement in bipartite states (two-part states), it is not formulated to extend naturally to multipartite states.

Some prior art utilizes the Schmidt decomposition as a primary tool for hierarchically creating low-rank decompositions of larger systems (i.e., multi-partite systems) by dividing them into bipartite sub-systems or bipartitions. This approach is proposed by Araujo et al., “Low-Rank Quantum State Preparation”, IEEE Trans., arXiv, 27 Jul. 2023, pp. 1-10. The authors adopt an iterative method, recursively disentangling suitable bipartitions at each step, until no further disentanglement is possible, achieving the lowest-rank representation.

Regarding the encoding of a quantum state, the prior art recognizes that various methods exist for handling the encoding of N complex-valued coefficients or amplitudes in a general quantum state |Ψ [symbol] . For instance, Grover et al., “Creating superpositions that correspond to efficiently integrable probability distributions”, Bell Labs, arXiv, 15 Aug. 2002, pgs. 1-2 describe a traditional deterministic method. However, this method requires O(N) (order N) quantum operations, making it impractical for large-scale implementations. Another deterministic approach leverages entanglement features through matrix-product-states (MPS). Schoen et al., “Sequential Generation of Matrix-Product States in Cavity QED”, Blackett Laboratory, Imperial College London, arXiv, 13 Dec. 2006, pgs. 1-11 propose generating sequential quantum operations to encode a quantum state, represented as a classical vector, into an MPS decomposition. MPS is widely used in physics for its great approximation properties. Building on this foundation, several studies expand the MPS approach with parameterized tensor-network methods to reduce quantum circuit depth and enable training on classical computer hardware. For further details, the reader is referred to Ran, Shi-Ju, “Encoding of matrix product states into quantum circuits of one- and two-qubit gates”, Physical Review A, 101, 2020, pgs. 1-7. Additionally, some prior art suggests iteratively applying a “disentangler operator” to the MPS format for enhanced performance.

Meanwhile, a different approach to the encoding problem using the Tucker decomposition is described by Protasov et al., “Faster Quantum State Decomposition with Tucker Tensor Approximation”, Springer, Nature, 2021, pgs. 1-15. Protasov proposes using the Tucker decomposition instead of the Schmidt decomposition or SVD, partly because the Tucker decomposition generalizes the SVD for one-versus-all comparisons and can therefore be applied beyond the bipartite (two-qubit) states. Notably, the Tucker decomposition employs a core tensor with the same number of modes and projection matrices, elegantly extending the Schmidt decomposition to multipartite systems.

To better appreciate the nature of the Tucker decomposition, and its modes in particular, FIG. 1I depicts an exemplary tensor T that has three modes (M=3). These modes, sometimes referred to as degrees by those skilled in the art, are I₁, I₂ and I₃ (columns, rows, tubes, respectively). They are visualized explicitly with an offset from tensor T in a diagrammatic manner for clarity. Tensor T is complex-valued and resides in the tensor space T∈ [symbol] ⊗ [symbol] ⊗ [symbol] . As illustrated, a single column or fiber picked from mode 1 is obtained by summing over the first mode while keeping the other two modes fixed.

In the general case, the Tucker decomposition expresses an arbitrary tensor T with M modes (M∈Z_{≥1}) as a transformation of a core tensor G, which retains the essential structural properties of tensor T, and a set of factor matrices {W⁽¹⁾, W⁽²⁾, . . . . W^{(M)}} for each mode i (i=1, 2, . . . , M). The factor matrices W⁽ⁱ⁾ contain basis vectors that span the principal subspaces associated with each mode of the original tensor T. This permits the Tucker decomposition to generalize the SVD for higher dimensional arrays.

Although Protasov teaches the use of the Tucker decomposition, no selection criterion is provided or suggested for determining which decomposition to use. However, since the Tucker decomposition is non-unique, providing no guidance on how to choose one decomposition over another presents a problem for a practitioner trying to deploy Protasov's teachings in practice. Additionally, when the solution is extended beyond one-versus-all comparisons, its advantage over the SVD approach vanishes. Furthermore, the teachings do not present a strategy for translating the data from the decomposition into a quantum circuit.

### OBJECTS AND ADVANTAGES

The present invention aims to overcome the challenges of prior art systems and approaches with a system and a method that employ a tensor decomposition suitable for multipartite systems, thereby avoiding the need for cumbersome hierarchical bipartitions.

A further object of the invention is to provide a system and method for performing an iterative search to identify a state vector for optimal quantum initialization. Advantageously, this process is guided by performance criteria that evaluate both the quality of the tensor decomposition and of the resulting state vector, ensuring an efficient quantum circuit decomposition.

### SUMMARY OF THE INVENTION

The objects and advantages of the invention are provided for by a system and a method for encoding classical data into an executable quantum state that has a number n of executable d-level qudits. The classical data is typically represented as an N-dimensional complex-valued vector (N=dⁿ). Qudits range from qubits, which are two-level (d=2) quantum mechanical objects described in a two-dimensional complex space [symbol] , to higher-dimensional multi-level quantum objects such as qutrits (d=3) and beyond.

The system has a non-transitory storage medium for holding the classical data that is to be loaded or encoded. Further, the system has an initial quantum circuit with a number n of initial qudits. The n initial qudits are in an initial state that is predetermined and hence known. For example, in the most common case of n initial qubits (number n of two-level quantum mechanical objects with d=2), all of them can start out in the ground state |0 [symbol] . Since they are unentangled they can be treated individually (i.e., |0 [symbol] ₁, |0 [symbol] ₂, . . . , |0 [symbol] ₙ).

The system has a loading device that is connected to or coupled to the non-transitory storage medium for receiving the classical data from it. Further, the loading device also loads the data onto the n executable qudits. To achieve this, the loading device has an input/output processor for initializing the classical data received from the non-transitory storage medium, thereby obtaining initialized data representing the n executable qudits. Conveniently, the initialized data is formatted as a dⁿ-dimensional complex-valued and normalized data vector. Once the initialization is complete, the input/output processor stores the initialized data back in the non-transitory storage medium.

The loading device is also equipped with a tensor processor for finding a first representation of the initialized data through a non-unique decomposition involving a tensor G and unitary operators. The unitary operators are represented as a list {W⁽¹⁾, W⁽²⁾, . . . , W^{(M)}}, where their number M corresponds to the number of modes (also sometimes referred to as the order) of tensor G. More precisely, the tensor processor finds a list of unitary operators {W⁽¹⁾, W⁽²⁾, . . . , W^{(M)}} while minimizing a decomposition performance measure, such as the level of entanglement of tensor G.

The loading device is further equipped with a circuit processor for translating the list of unitary operators {W⁽¹⁾, W⁽²⁾, . . . , W^{(M)}} into a quantum gate set. The circuit processor applies this quantum gate set to the initial quantum circuit containing n initial qudits. This process yields a prepared quantum circuit in the executable quantum state, which now has n executable qudits instead of the original n unentangled qudits in the known initial state. Additionally, the loading device has a quantum circuit executor for evaluating a state approximation performance measure of the executable quantum state.

In accordance with the invention, the system uses the decomposition performance measure and the state approximation performance measure as guides in an iterative process aimed at improving the representation of the initialized data. During this iterative process, the tensor processor determines a second representation of the initialized data stored in the non-transitory storage medium as long as the decomposition performance measure and the state approximation performance measure exceed certain thresholds. In other words, the iterative process continues while the performance measures remain outside an acceptable range.

One of the key aspects of the invention is that the representation of the initialized data is implemented using the Tucker decomposition. The Tucker decomposition employs a tensor G along with factors that are treated as unitary operators in this context. In the present system, tensor G is a core-tensor of the Tucker decomposition and establishes correlations between the factors. To improve performance, it is advantageous to reduce the representation. Accordingly, the tensor processor of the loading device reduces the first representation of the initialized data to a low-rank tensor, such as a low-rank approximation or a low-rank representation of tensor G, referred to herein as core-tensor G′. Furthermore, due to the reduced correlation between them, the list of unitary operators {W⁽¹⁾, W⁽²⁾, . . . , W^{(M)}} of the reduced first representation can be rewritten as isometry operators.

An isometry is a mathematical operation that maps s qudits to n qudits, where sin, and is represented by a dⁿ×d^{s} matrix V satisfying V^{†}V=I, which preserves the inner products of input states. Unitary operations and state preparation are special cases of isometries, corresponding to s=n and s=0, respectively. When s≠n, an isometry can be implemented by extending it to a unitary matrix and executing the unitary operation instead. This extension provides additional flexibility, allowing for a more efficient decomposition with fewer quantum gates. Consequently, the circuit processor can translate these isometry operators into a second quantum gate set with a lower complexity measure than that of the original unitary operators. The complexity measure used in this system is preferably based on Kolmogorov complexity, entangling-gate complexity or T-gate complexity.

The system has a quantum mechanical computing device, such as a quantum computer or quantum processing unit (QPU). This quantum mechanical computing device is configured for receiving control-sequences for the prepared quantum circuit and executing the n executable qudits. Since the n executable qudits are multi-level quantum mechanical objects manipulated by the control-sequences, the quantum mechanical computing device must be capable of accommodating them. This requirement also applies to two-level quantum mechanical objects, commonly referred to as qubits. Suitable quantum mechanical computing devices belong to the group that supports corresponding multi-level mechanisms. Specifically, these mechanisms include lasers, magnets, optics and electronics that serve as receivers for the control-sequences. Moreover, the quantum gate set is chosen from the group of quantum gates that include single-qudit rotations and two- or three-qudit entangling gates. Note that the number of levels in these gates is dictated by the level of the qudit; for qubits, only two-level compatible gates are required. Specific embodiments of suitable quantum gates include those that perform Pauli-Rotations, universal unitary rotations, CNOT, Toffoli gates or their derivatives.

The choice of decomposition and state approximation performance measures is important, since these measures guide the iterative process of finding a desirable Tucker decomposition. They are preferably selected from among fidelity, level of entanglement, time required to create the executable quantum state, compression level and suitable loss measures. Moreover, the finding operation performed iteratively by the tensor processor can employ various techniques. Preferably, it uses a search method that involves iterating over communities of vertices within a graph. The graph consists of edges weighted by the initialized data representing the n executable qudits. In this context, the weights are based on the mutual information between qudits in the n executable qudits.

The present invention, including the preferred embodiment, will now be described in detail in the below detailed description with reference to the attached drawing figures.

### BRIEF DESCRIPTION OF THE DRAWING FIGURES

FIG. 1A (PRIOR ART) is a Bloch sphere representation of single-qubit state |0 [symbol] that corresponds to classical bit value 0

FIG. 1B (PRIOR ART) is a Bloch sphere representation of single-qubit state |1 [symbol] that corresponds to classical bit value 1

FIG. 1C (PRIOR ART) is a Bloch sphere representation of single-qubit state |ψ [symbol] that has no classical bit analogue

FIG. 1D (PRIOR ART) is a representation of two unentangled qubits in a factorizable tensor product state

FIG. 1E (PRIOR ART) is a representation of two maximally entangled qubits, whose tensor product state is not factorizable

FIG. 1F (PRIOR ART) is a representation of an entangled state of two qubits and its Schmidt decomposition, used to quantify the level of entanglement

FIG. 1G (PRIOR ART) illustrates tensorization of two unentangled qubits and the corresponding Schmidt decomposition (Singular Value Decomposition (SVD)) no entanglement (factorizable state)

FIG. 1H (PRIOR ART) illustrates the tensorization of two maximally entangled qubits and the confirmation of maximal entanglement using the SVD

FIG. 1I (PRIOR ART) illustrates the modes of a tensor T

FIG. 2 is a schematic diagram of a system for encoding or loading classical data onto qubits according to the invention

FIG. 3A is a flow diagram illustrating the operation of the system shown in FIG. 2

FIG. 3B is a portion of the flow diagram from FIG. 3A, focusing on the iteration process to find an optimal decomposition based on decomposition performance measure and state approximation performance measure

FIG. 4A illustrates an initial arrangement of unitary operators obtained after the first pass according to the method of invention

FIG. 4B illustrates successive gate layers of unitary operators obtained during subsequent iterations on the initial arrangement of operators from FIG. 4A

FIG. 5 is a plot of the fidelity of approximate quantum states over successive iterations, where the fidelity between the approximate state and the original state serves as the state approximation performance measure

### DETAILED DESCRIPTION

The figures and the following description relate to preferred embodiments of the present invention by way of illustration only. It should be noted that, based on the following discussion, alternative embodiments of the structures and methods disclosed herein will be readily recognized as viable alternatives that can be employed without departing from the principles of the claimed invention.

Reference will now be made in detail to several embodiments of the present invention, examples of which are illustrated in the accompanying figures. Wherever practicable, similar or identical reference numbers are used in the figures to denote similar or identical functionality. The figures depict embodiments of the present invention for purposes of illustration only. One skilled in the art will readily recognize from the following description that alternative embodiments of the structures and methods illustrated herein may be employed without departing from the principles of the invention described herein.

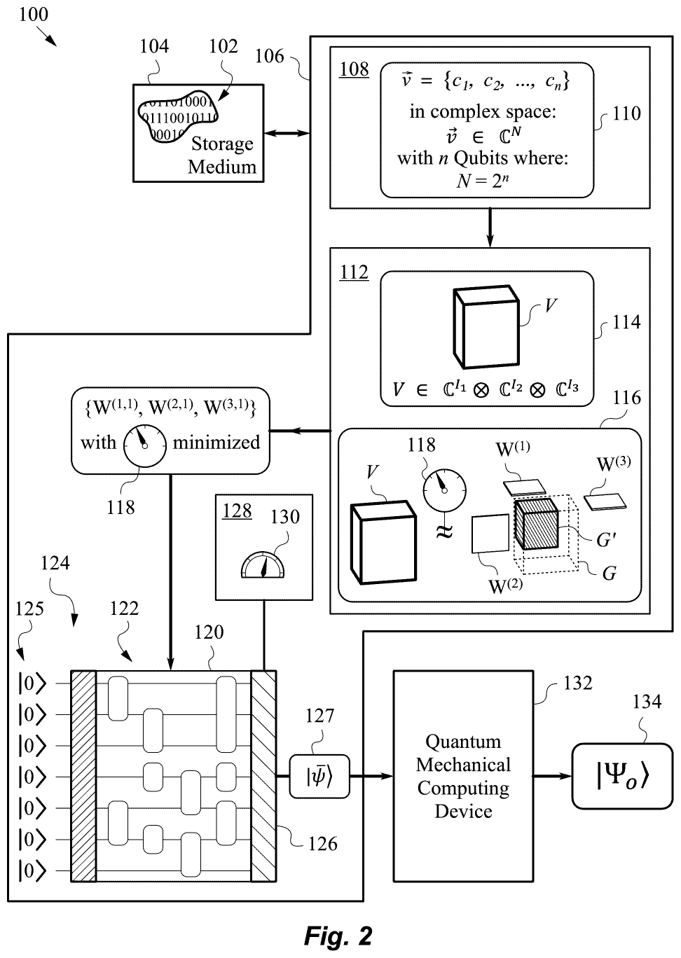

FIG. 2 is a schematic diagram of a system 100 for encoding classical data 102 stored in a non-transitory storage medium 104 into a quantum state. Classical data 102 is schematically represented in binary digital form within storage medium 104. Typically, classical data 102 is intended from the outset to encode a quantum state that is of interest to a user of system 100. Given the classical nature of data 102, storage medium 104 can be any suitable repository, such as computer-readable media (CRM), that stores classical data 102 in a stable manner.

System 100 has a loading device 106 that is connected to or coupled to storage medium 104. The connection between loading device 106 and storage medium 104 enables classical data 102 to be received by loading device 106 from storage medium 104. In the present embodiment, data 102 is transferred or passed to loading device 106 to be encoded onto or loaded onto qubits, which are two-level quantum mechanical objects. It is noted that while classical data 102 can also be encoded onto multi-level quantum mechanical objects or qudits (also known as quantum digits), the present embodiment focuses on qubits for reasons of clarity of explanation and because many quantum computers operate with qubits.

Loading device 106 has an input/output processor 108 (I/O processor 108 hereafter) for initializing classical data 102 prior to encoding. For initialization, I/O processor 108 converts classical data 102 it receives into a complex-valued and normalized vector \vec{v} specified by complex numbers {c₁, c₂, . . . , cₙ} and occupying complex space [symbol] . Once in this: form, classical data 102 becomes initialized data 110. Vectorizing data is, of course, a well-known procedure in the art. In the general case of a multi-level qudit with d levels (i.e., a d-level qudit), initialized data 110 becomes a dⁿ-dimensional complex-valued and normalized vector (i.e, N=dⁿ). In this case, which focuses on qubits, the dimensionality is N=2ⁿ, since qubits are just two-level quantum mechanical objects.

After initialization, I/O processor 108 stores initialized data 110 in non-transitory storage medium 104. For completeness, it is noted that complex-valued and normalized vector \vec{v} obtained by I/O processor 108 through initialization can be expressed as either a column or a row vector in Dirac notation (i.e., as a ket vector |v [symbol] or its dual bra vector [symbol] v|). The Dirac formulation is more customary in the context of several formalisms used below (e.g., measure of state fidelity f).

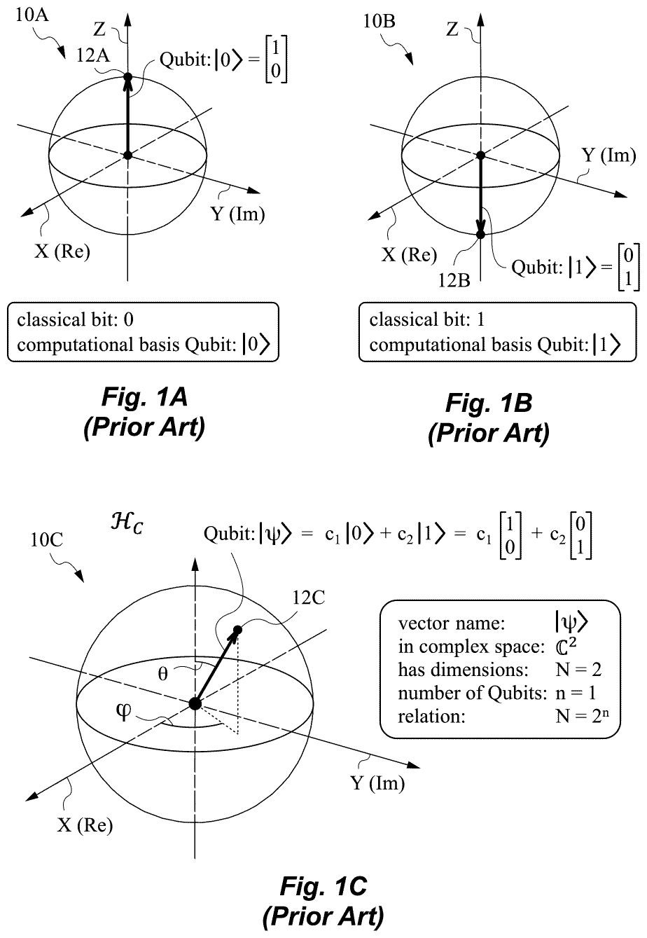

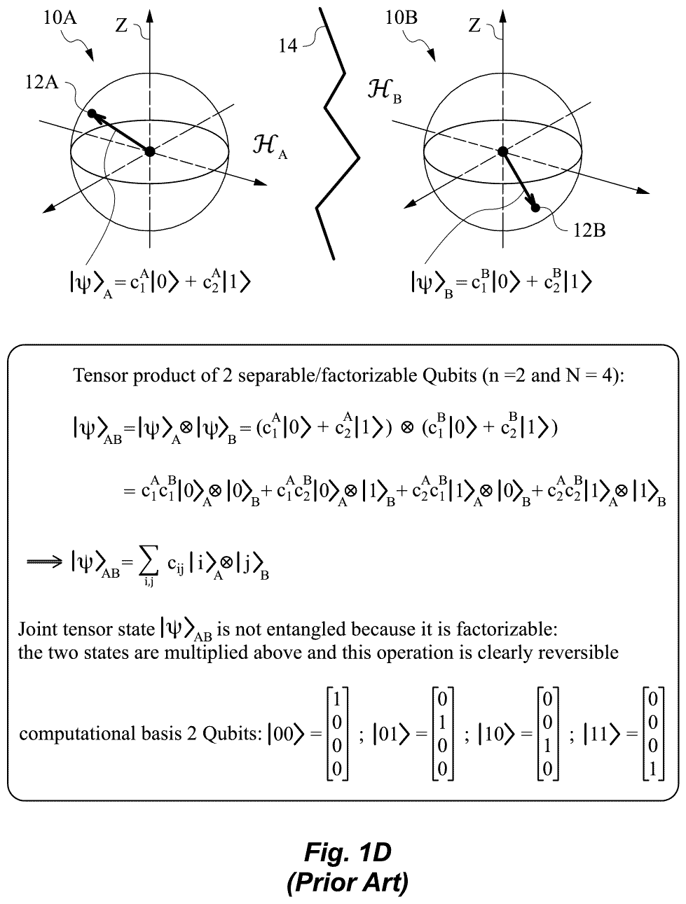

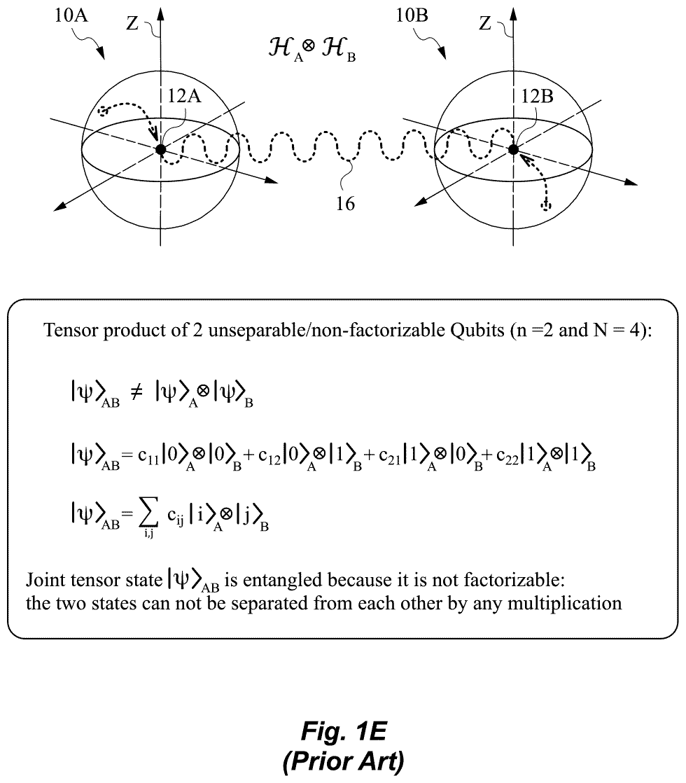

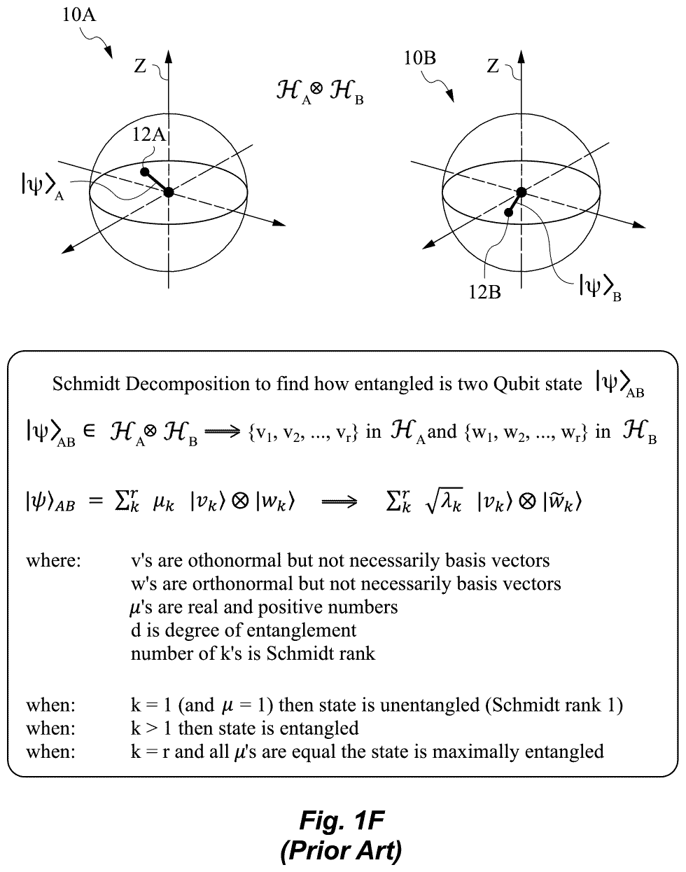

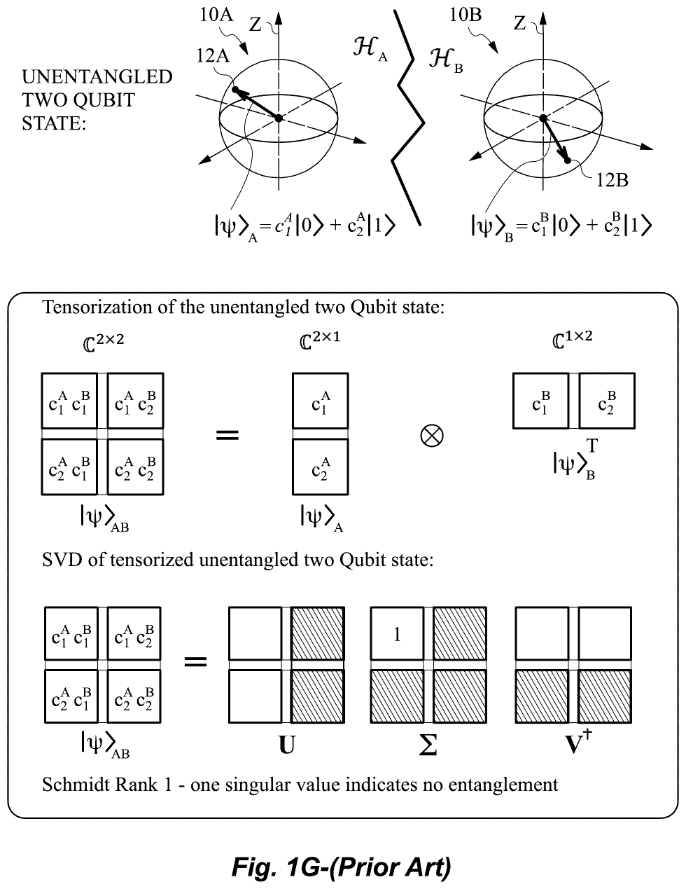

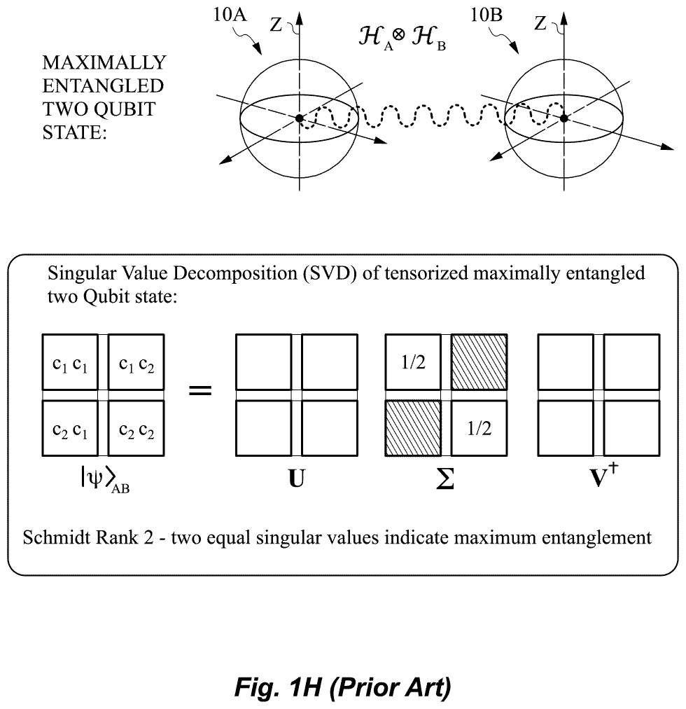

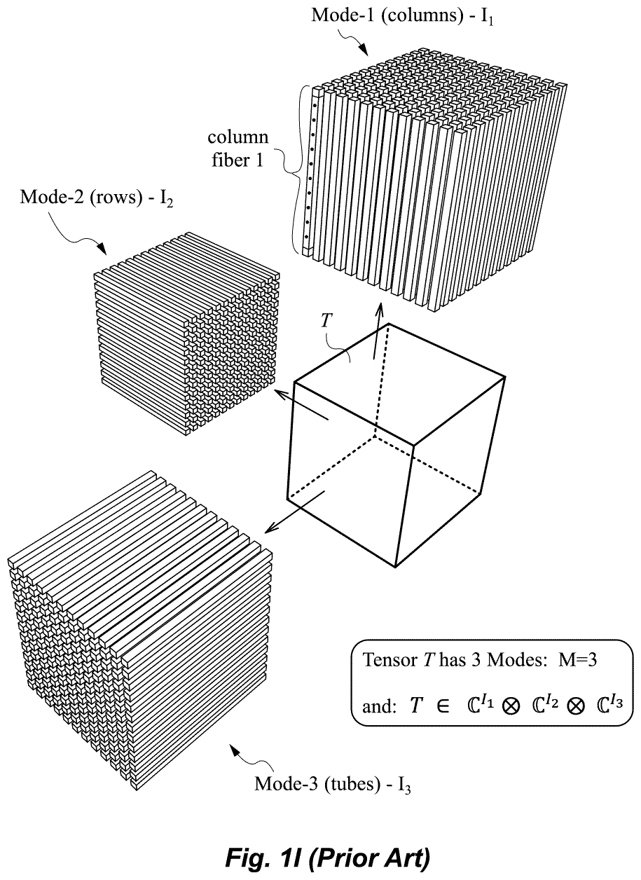

Loading device 106 also has a tensor processor 112 for finding a tensorized representation 114 of initialized data 110. To produce tensorized representation 114, which takes the form of a tensor V, initialized data 110 must first be converted into tensor form, a process known as tensorization. The tensorization process is well known in the art (see also Background Section in conjunction with FIG. 1G). For clarity, tensor V is visualized with only three orders or three modes (M=3). Thus, tensor V is a 3-tensor that inhabits a complex space corresponding to the three complex modes (M=3), expressed as [symbol] ⊗ [symbol] ⊗ [symbol] . In the language of those skilled in the art, this is represented as V∈ [symbol] ⊗ [symbol] ⊗ [symbol] .

It is important to note that the tensorization from \vec{v}∈ [symbol] in initialized data 110 to tensor V∈ [symbol] ⊗ [symbol] ⊗ [symbol] in tensorized representation 114 is always possible but it is not unique. In fact, different tensorizations can generate tensors V with varying entanglement behavior. For example, swapping of modes or performing swap operations results in different ordering or indexing of the modes (different choices or orderings of M) and generate tensors V with distinct entanglement properties.

Additionally, tensor processor 112 is also capable of swapping qudits (in the present example qubits) to concentrate entanglement into specific subsystems, reducing the need for long range correlations. This can be achieved using SWAP operations to rearrange qudit states without changing the system's total entropy. However, the initial set of SWAPs can be performed logically by properly mapping logical and physical qubits, incurring zero quantum cost. This allows for an optimized arrangement of entangled qudits before any quantum operations are applied. By strategically structuring the mapping, the number of entangling gates required for state initialization decreases, minimizing circuit depth and improving fidelity on noisy quantum hardware. SWAPS thus serve as an effective tool to restructure entanglement efficiently, making state preparation more resource-efficient, while maintaining the desired quantum correlations.

To find an optimal configuration of tensor V, it is important for tensor processor 112 to search through tensorization configurations. An exemplary search approach is based on solving the graph problem of finding best match-up. In this approach, the search identifies a best match-up on a graph GR=(VT, ED), where the qubits are represented by vertices VT and the edges ED between the vertices are weighted by the mutual information between any two connected qubits.

According to the invention, the search process executed by tensor processor 112 for the optimal configuration of tensor V further involves placing it in a first representation 116 that is non-unique and includes a tensor G and unitary operators W. More precisely, first representation 116 is a decomposition where tensor V is approximated by tensor G and unitary operators acting on the different modes of tensor G. Unitary operators W are represented as a list {W⁽¹⁾, W⁽²⁾, . . . , W^{(M)}}, where M corresponds to the number of modes of tensor G. In the current example, with three modes, the list contains three unitary operators: {W⁽¹⁾, W⁽²⁾, W⁽³⁾}. In fact, unitary operators W are derived from the left unitary matrices obtained during the Singular Value Decomposition (SVD) of their respective modes. Their dimensions match to those of the modes of tensor G, specifically W⁽¹⁾∈ [symbol] , W⁽²⁾∈ [symbol] , W⁽³⁾∈ [symbol] . This type of decomposition is known as the Tucker decomposition, where tensor G is analogous to the Σ tensor that contains the singular values in the SVD decomposition.

In the Tucker decomposition, tensor G holds the singular values for each of the modes. For the three-mode tensor G in the present example, the Tucker decomposition is expressed as:

$$T = G {\times }_{1} {W}^{( 1 )} {\times }_{2} {W}^{( 2 )} {\times }_{3} {W}^{( 3 )} , \qquad Eq . 4$$

where the subscripts of the tensor product operators refer to the modes explicitly (i.e., x₁ denotes the product for mode 1). When representing the decomposition of a low-entangled mode, tensor G is truncated to the so-called core-tensor G′, which has fewer entries in that mode. This is visualized in first representation 116 shown in FIG. 2. Specifically, with tensor V∈ [symbol] ⊗ [symbol] ⊗ [symbol] , core-tensor G′∈ [symbol] ⊗ [symbol] ⊗ [symbol] has at most as many entries as V for highly entangled modes and fewer for modes exhibiting lower entanglement. In other words, when examining core-tensor G mode-by-mode, we find Jᵢ≤Iᵢ. In FIG. 2, all modes of core-tensor G′ satisfy the condition Jᵢ<Iᵢ, accounting for the smaller size of core-tensor G′. All three modes are truncated or recessed relative to the full size of tensor G, for which Jᵢ=Iᵢ, as indicated by dashed lines in FIG. 2.

The truncation of the modes of core-tensor G′ results in correspondingly smaller factors or unitary operators W. Specifically, unitary operators W now have dimensions W⁽¹⁾∈ [symbol] , W⁽²⁾∈ [symbol] , W⁽³⁾∈ [symbol] (or, more succinctly, W⁽ⁱ⁾∈ [symbol] ). This format is well-suited for quantum computing, as the tensor decomposition of tensor V corresponds to:

$$\vert \overline{ψ} 〉 = ( {W}^{( 1 )} ⊗ {W}^{( 2 )} ⊗ {W}^{( 3 )} ) \vert {ψ}_{{G}^{′}} 〉 , \qquad Eq . 5$$

where state vector |ψ [symbol] represents the approximated executable quantum state. We denote operators W⁽ⁱ⁾ with the same symbol as the factors, even if their dimensions do not match (Jᵢ≠Iᵢ). In such cases, the columns are filled with vectors from the kernel. After vectorization, core-tensor G′ is interpreted as quantum state |ψ_{G} [symbol] , more specifically as |ψ_{G′} [symbol] when reduced to core-tensor G′.

A crucial aspect of the present invention is that the factors are interpreted as unitary operators W⁽ⁱ⁾ acting on the separate modes or on the subspaces. This Tucker format is also referred to as the subspace-format by those skilled in the art. The advantage of this interpretation becomes evident in the discussion of the iterative process applied in system 100, as described further below.

To monitor the performance of a particular decomposition of tensor V, tensor processor 112 of system 100 employs a decomposition performance measure 118. In the present embodiment, decomposition performance measure 118 quantifies the level of entanglement in tensor G or core-tensor G′. Decomposition performance measure 118 is thus expressed by tensor G or core-tensor G′ itself, specifically relating to the number of non-zero entries in core-tensor G′ and their values. As the iterative search for the optimal representation progresses (as explained in more detail below), system 110 advantageously arrives at tensor G or core-tensor G′ with the lowest possible geometric entanglement, as determined by decomposition performance measure 118.

The objective of tensor processor 112 is also to find a specific list of unitary operators {W⁽¹⁾, W⁽²⁾, . . . , W^{(M)}} in the Tucker decomposition while minimizing decomposition performance measure 118, as indicated schematically. Differently put, tensor processor 112 attempts to find the best performing core-tensor G′ according to decomposition performance measure 118 and also finds the corresponding unitary operators {W⁽¹⁾, W⁽²⁾, . . . , W^{(M)}} for each mode of core-tensor G′. In the present example, where core-tensor G′ has three modes, tensor processor 112 generates a list of three unitary operators {W⁽¹⁾, W⁽²⁾, W⁽³⁾}, based on geometric entanglement measure 118 of core-tensor G′ obtained on the first pass. Further minimization of geometric entanglement 118 may be achieved through the iterative process, in accordance with the invention, and as described above and explained in more detail below. During this process, the three unitary operators in list {W⁽¹⁾, W⁽²⁾, W⁽³⁾} are iteratively rederived.

Given a Tucker decomposition with core-tensor G′ exhibiting minimized geometric entanglement 118, the list of unitary operators {W⁽¹⁾, W⁽²⁾, W⁽³⁾} is prepared for the first or initial iteration. Tensor processor 112 assigns this initial list of unitary operators {W⁽¹⁾, W⁽²⁾, W⁽³⁾} with a first permutation count, denoted as π₁. The fully designated list of unitary operators thus becomes {W^{(1,1)}, W^{(2,1)}, W^{(3,1)}}, where the second superscript denotes the permutation count (i.e., W^{(1,1)} refers to the first permutation π₁ of first unitary operator W⁽¹⁾). Naturally, this fully designated list {W^{(1,1)}, W^{(2,1)}, W^{(3,1)}} corresponds to core-tensor G′. The associated quantum state |ψ_{G′} [symbol] is expressed by vectorizing core-tensor G′ and multiplying it by the product of factors or unitary operators {W^{(1,1)}, W^{(2,1)}, W^{(3,1)}}, as shown in Eq. 5 above.

Tensor processor 112 of loading device 106 is connected to a circuit processor 120. Using the connection, tensor processor 112 supplies circuit processor 120 with the designated list of unitary operators {W^{(1,1)}, W^{(2,1)}, W^{(3,1)}} in permutation π₁, obtained under the condition that decomposition performance measure 118, i.e., geometric entanglement of core-tensor G′, is minimized. Circuit processor 120 translates the designated list of unitary operators {W^{(1,1)}, W^{(2,1)}, W^{(3,1)}} into a quantum gate set 122. In particular, circuit processor 120 designs quantum gate set 122 to be applied to a duly prepared initial quantum circuit 124 that has a number n of initial qudits. In the present specific example, the n initial qudits are n initial qubits 125. All n initial qubits 125 are in an initial state that is known. In the present example, all n initial qubits 125 are unentangled and in a common state. Specifically, the n initial qubits 125 are all in the ground state |0 [symbol] (or qubit |0 [symbol] ) corresponding to the binary 0 state.

Thus configured, loading device 106 uses its tensor processor 112 to load or encode data 102, which has been vectorized, tensorized and decomposed using the Tucker decomposition onto n initial qubits 125 of initial quantum circuit 124. The encoding or loading is formally accomplished by applying quantum gate set 122 to initial quantum circuit 124, resulting in a prepared quantum circuit 126. The approximate vector state |ψ̅ [symbol] is thus represented as executable quantum state |Ψ [symbol] , consisting of n executable qubits 127 (not shown in expanded form).

Loading device 106 has a quantum circuit executor 128 for obtaining a state approximation performance measure 130 of executable quantum state |Ψ [symbol] with n executable qubits 127. In the present example, state approximation performance measure 130 is the fidelity between approximated state represented by executable quantum state |Ψ [symbol] and the original state expressed in initialized data 110 as 2ⁿ-dimensional complex-valued and normalized data vector \vec{v}. Fidelity f is a measure of the closeness or overlap between two states, either in their vectorized form or in their density matrix form, and it ranges from 0 to 1. In the present example, quantum circuit executor 128 computes fidelity f between vector state \vec{v}, expressed as [symbol] v| or bra vector in Dirac notation, and the ket of vector |ψ [symbol] obtained from Eq. 5 which represents executable quantum state |Ψ [symbol] with n executable qubits 127. To avoid ambiguity, since Eq. 5 yields an approximate state, the corresponding ket vector is denoted herein by an overbar as |ψ̅ [symbol] . Fidelity f is calculated as follows:

$$f = {\vert 〈 v \vert \overline{ψ} 〉 \vert}^{2} . \qquad Eq . 6$$

When fidelity f equals 1, state approximation performance measure 130 is considered minimized, indicating that the approximated vector state |ψ̅ [symbol] perfectly matches or completely overlaps with normalized data vector \vec{v} from initialized data 110, as obtained by I/O processor 108 from classical data 102. However, achieving a perfect or near-perfect approximation is highly unlikely. Therefore, when fidelity f representing state approximation performance measure 130 is initially computed by quantum circuit executor 128, its value is typically less than, and often significantly less than 1.

System 100 has a quantum mechanical computing device 132, such as a quantum computer or quantum processing unit (QPU). Quantum mechanical computing device 132 is configured to receive control-sequences corresponding to prepared quantum circuit 126, which is in executable quantum state |Ψ [symbol] with n executable qubits 127. The output of quantum mechanical computing device 132 is the fully prepared and physically instantiated quantum mechanical state 134, designated as |Ψₒ [symbol] .

Generally, quantum mechanical computing device 132 is capable of executing n executable qudits. In the present example, which delivers executable quantum state |Ψ [symbol] with n executable qubits 127, the quantum mechanical computing device 132 operates with two-level systems (d=2). In other words, in the present example quantum mechanical computing device 132 works with two-level quantum mechanical objects that represent qubits. These include single-qubit rotations and two-qubit entangling gates, such as physical implementations of the Hadamard and CNOT gates.

The specific hardware of quantum mechanical computing device 132 is well-known in the art. It includes hardware mechanisms such as lasers, magnets, optics and electronics that receive the control sequences. Moreover, the physical quantum gate set is selected from among suitable quantum gates that perform operations that include rotations, flips, entanglements and other phase operations. Specific embodiments of suitable quantum gates include those that perform Pauli-Rotations, universal unitary rotations, CNOT, Toffoli gates or their derivatives.

In accordance with the invention, system 100 uses decomposition and state approximation performance measures 118 and 130 to guide an iterative process aimed at improving the representation of initialized data 110. In the present example, it is the geometrical entanglement of core-tensor G′ and fidelity f between approximated vector state |ψ̅ [symbol] , expressing executable quantum state |Ψ [symbol] of n executable qubits 127, and vector state \vec{v} in initialized data 110 that guide the iterative process.

In an alternative embodiment, I/O processor 108, tensor processor 112 and circuit processor 120 can be implemented as logical components within a single physical processor or they can be distributed across multiple processors. In other words, although I/O processor 108, tensor processor 112 and circuit processor 120 perform distinct computational tasks and are separate in the preferred embodiment, they can be integrated within a single physical processor. When implemented in a single processor, sufficient computational resources need to be made available to sequentially or concurrently execute the tasks assigned to I/O processor 108, tensor processor 112 and circuit processor 120. Conversely, when distributed across multiple processors, e.g., a network of processors each specializing in a subset of the required tasks, parallel execution needs to be enabled. Such distributed implementation is likely to improve efficiency, which is the reason that the preferred embodiment implements I/O processor 108, tensor processor 112 and circuit processor 120 in separate processing units. The flexibility in implementation allows for adaptation to different hardware architectures while maintaining the core functionality of the present invention. In particular, the various hardware architectures can leverage the strengths of different processor types, such as CPUs, GPUS, Field-Programmable Gate Arrays (FPGAs), QPUS and the like, to achieve desired levels of efficiency given any particular set of implementation goals imposed on system 100 in practice.

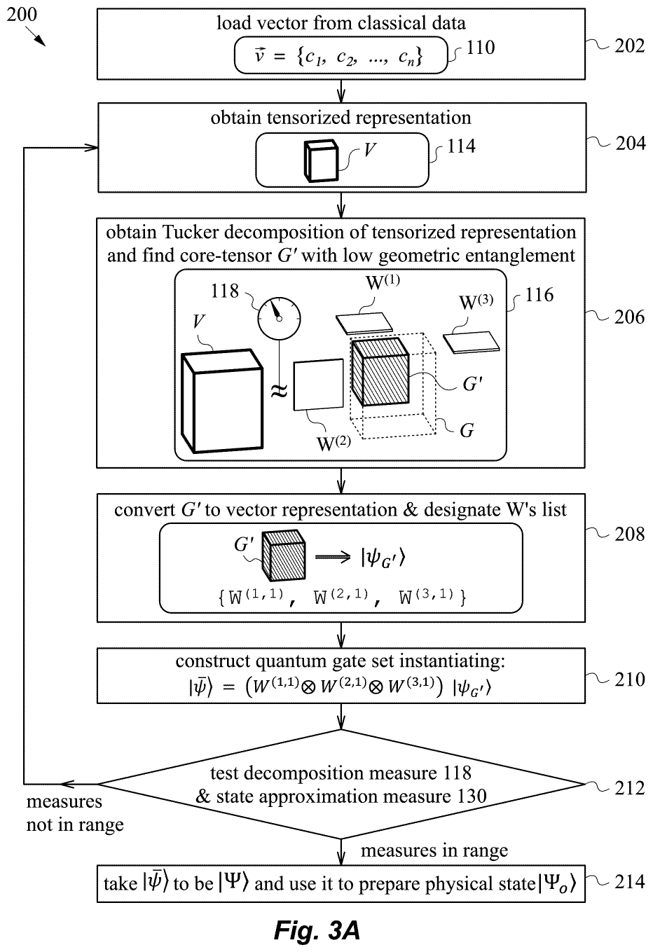

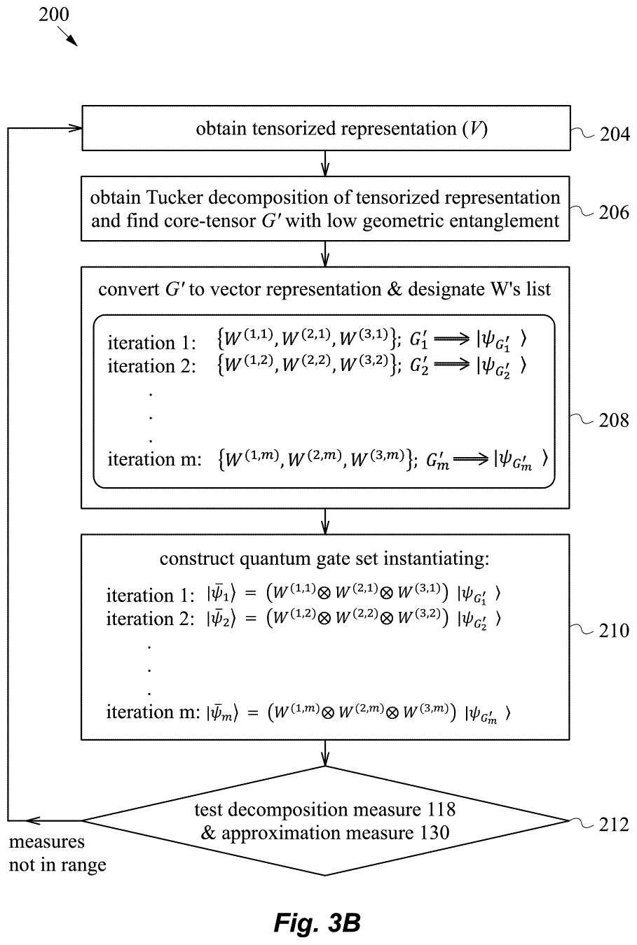

FIG. 3A illustrates a flow diagram 200 of an iterative process performed by system 100. Flow diagram 200 is focused on the results of a first pass in the iterative process. The steps in flow diagram 200 make reference to system 100 and its parts using their respective reference numerals.

In a first step 202, classical data 102 (see FIG. 2) is loaded as a complex-valued and normalized vector \vec{v} specified by complex numbers {c₁, c₂, . . . , cₙ} and occupying complex space [symbol] , where N=2ⁿ and n is the number of qubits. This step is performed by I/O processor 108 of loading device 106. Prepared and formulated in this manner, complex-valued and normalized vector \vec{v} represents initialized data 110. Note that vector \vec{v}, or initialized data 110, is also kept for future comparisons and computations by being stored in non-transitory storage medium 104 (step not explicitly shown in flow diagram 200).

In a second step 204, tensorized representation 114 of vector \vec{v} of initialized data 110 is formulated. Tensorized representation 114 takes on the form of tensor V. Step 204 is performed by tensor processor 112.

In a third step 206, tensorized representation 114 is used to determine first representation 116 that is decomposed using the Tucker decomposition. Specifically, tensor V of tensorized representation 114 is approximated by the Tucker decomposition with the aid of tensor G and factors that, in accordance with the present invention, are interpreted as unitary operators W. Tensor G and unitary operators W jointly define first representation 116.

Furthermore, third step 206 also reduces tensor G. In particular, it finds core-tensor G′ that exhibits minimized decomposition performance measure 118, which is taken to be geometric entanglement in the present exemplary embodiment. Thus, the list of unitary operators {W⁽¹⁾, W⁽²⁾, W⁽³⁾} belonging to first representation 116, as shown in flow diagram 200, is for core-tensor G′ that is found in the search that minimized geometric entanglement 118, rather than for tensor G. Both tensorized representation 114 and first representation 116, with reduced core-tensor G′, are performed by tensor processor 112.

In a fourth step 208, core-tensor G′ from first representation 116 is converted to its vector representation. In other words, core-tensor G′ is vectorized to obtain quantum state |ψ_{G′} [symbol] . In addition, the list of unitary operators {W⁽¹⁾, W⁽²⁾, W⁽³⁾} is denoted with the first permutation π₁ to obtain the fully designated list of unitary operators {W^{(1,1)}, W^{(2,1)}, W^{(3,1)}}. These operations of step 208 are also performed by tensor processor 112.

In a fifth step 210, quantum state |ψ_{G′} [symbol] and designated list of unitary operators {W^{(1,1)}, W^{(2,1)}, W^{(3,1)}} are delivered from tensor processor 112 to circuit processor 120. Circuit processor 120 translates the designated list of unitary operators {W^{(1,1)}, W^{(2,1)}, W^{(3,1)}} into a quantum gate set 122 that acts on quantum state |ψ_{G′} [symbol] to yield vector state |ψ [symbol] which is the approximated executable quantum state. The action of designated list of unitary operators {W^{(1,1)}, W^{(2,1)}, W^{(3,1)}} on quantum state |ψ_{G′} [symbol] to yield approximated vector state |ψ [symbol] is captured by Eq. 5 already presented above. In the particular instance of applying the first permutation π₁ of unitary operators Eq. 5 specifies that vector state |ψ [symbol] is obtained as follows: |ψ̅ [symbol] =(W^{(1,1)}⊗W^{(2,1)}⊗W^{(3,1)})|ψ_{G′} [symbol] .

In a sixth step 212, loading device 106 determines the values of decomposition performance measure 118 for core-tensor G′ and state approximation performance measure 130 for approximate vector state |ψ̅ [symbol] . It is noted that measures 118 and 130 are obtained for core-tensor G′ in the first or initial decomposition and for first permutation of unitary operators {W^{(1,1)}, W^{(2,1)}, W^{(3,1)}}. In other words, the results correspond to the initial or first iteration of the iterative process. If measures 118 and 130 are within acceptable ranges or above certain thresholds, then the process proceeds directly to a final step 214 without further iterations.

In final step 214, approximate vector state |ψ̅ [symbol] is taken as executable quantum state |Ψ [symbol] with n executable qubits 127. This executable quantum state |Ψ [symbol] is then used by quantum mechanical computing device 132 to prepare physical state |Ψₒ [symbol] . At this point, the process terminates.

In an alternative embodiment, decomposition performance measure 118 and state approximation performance measure 130 can be defined using different figures of merit beyond geometric entanglement and fidelity, respectively. For example, in an alternative embodiment, decomposition performance measure 118 can be based on other entanglement quantifiers, such as mutual information. This allows for different optimization criteria when reducing core-tensor G′. Similarly, in an alternative embodiment, state approximation performance measure 130 can employ alternative distance metrics, such as trace distance, to assess how closely approximate vector state |ψ̅ [symbol] matches the target state. These alternative measures provide flexibility in tailoring the decomposition and approximation process to specific computational goals that may be imposed on system 100 in practice.

FIG. 3B illustrates the repetition of the process, focusing on the loop portion of flow diagram 200 that is repeated when performance measures 118 and 130 are not above certain thresholds or outside acceptable ranges. Specifically, when decomposition performance measure 118, which is the level of geometric entanglement of core-tensor G′, is not minimized (i.e., is too high), step 212 reverts back to step 204. In step 204, tensor V is found again, but this time for core-vector or quantum state |ψ_{G′} [symbol] obtained during the first or initial pass.

The process then continues with step 206, in which the Tucker decomposition is performed for a second time to find second core-tensor G′. In this second decomposition, core-tensor G′ exhibits lower geometric entanglement. In other words, decomposition performance measure 118 for second core-tensor G′ is closer to minimal.

Step 208 obtains second permutation of unitary operators {W^{(1,2)}, W^{(2,2)}, W^{(3,2)}} for second core-tensor G′. For clarity, the output of step 208 for the first and second iterations are expressly indicated in FIG. 3B. A subscript is deployed to indicate the iteration of core-tensor G′ as well. In other words, during first or initial pass, step 208 produces the first list of unitary operators {W^{(1,1)},W^{(2,1)},W^{(3,1)}}, along with core-tensor G₁′ and its vectorized representation, which corresponds to the quantum state |ψ_{G}_{₁}_{′} [symbol] . During the second iteration, step 208 produces the second list of unitary operators {W^{(1,2)},W^{(2,2)},W^{(3,2)}}, along with vectorized core-tensor G₂′ and its vectorized representation, which corresponds to the quantum state |ψ_{G}_{₂}_{′} [symbol] .

During second iteration, step 210 delivers quantum state |ψ_{G}_{₂}_{′} [symbol] and second list of unitary operators {W^{(1,2)},W^{(2,2)},W^{(3,2)}} to circuit processor 120. Circuit processor 120 translates second list of unitary operators {W^{(1,2)},W^{(2,2)},W^{(3,2)}} into a quantum gate set 122 that acts on quantum state |ψ̅_{G}_{₂}_{′} [symbol] to yield vector state |ψ̅ [symbol] , which is the second approximated executable quantum state in accordance with Eq. 5. To keep track of the iteration, vector state |ψ̅ [symbol] is provided with a corresponding subscript in FIG. 3B. In other words, second approximated vector state |ψ̅₂ [symbol] is obtained as follows: |ψ̅₂ [symbol] =(W^{(1,2)}⊗W^{(2,2)}⊗W^{(3,2)})|ψ̅_̅{̅G̅}̅_̅{̅₂̅}̅_̅{̅′̅}̅ [symbol] . For the sake of completeness, FIG. 3B also shows duly subscripted approximated vector state |ψ̅₁ [symbol] obtained in the first pass in the same manner, namely: |ψ̅₁ [symbol] =(W^{(1,1)}⊗W^{(2,1)}⊗W^{(3,1)}⊗)|ψ̅_{G}_{₁}_{′} [symbol] .

In the second iteration, step 212 again determines the values of decomposition performance measure 118, now for core-tensor G₂′ and state approximation performance measure 130 for second approximate vector state |ψ̅₂ [symbol] . Once again, if performance measures 118 and 130 are within acceptable ranges or above certain thresholds, then the process advances to final step 214 (see FIG. 3A).

In the present example, however, performance measures 118 and 130 are not within acceptable ranges until the m-th iteration is reached. The corresponding results for the m-th iteration of steps 208 and 210 are indicated in FIG. 3B. For step 208, it is the m-th list of unitary operators {W^{(1,m)},W^{(2,m)},W^{(3,m)}}, along with core-tensor Gₘ′ and its vectorized representation, which corresponds to the quantum state |ψ_{G}_{ₘ}_{′} [symbol] . For the m-th iteration of step 210, it is the m-th approximated vector state |ψ̅ₘ [symbol] , obtained as follows: |ψ̅ₘ [symbol] =(W^{(1,m)}⊗W^{(2,m)}⊗W^{(3,m)})|ψ_{G}_{ₘ}_{′} [symbol] .

Note that, although FIG. 3B illustrates the process for a tensor with three modes, the method is not limited to this specific case. The same iterative procedure can be applied to tensors with any number of modes, making the system and method of invention suitable for higher-dimensional quantum systems. In the general case, the decomposition operates on an M-mode tensor, where each mode contributes a corresponding unitary transformation in the factorized representation. The iterative refinement of the core-tensor and unitary operators remains unchanged, with the optimization process adapting to the increased number of modes accordingly. This flexibility ensures that the method of invention can handle multi-partite quantum systems of varying complexity, preserving its effectiveness beyond the three-mode example provided. Indeed, the three-mode example was chosen for reasons of clarity. A person skilled in the art will be able to adapt the method of invention to a larger number of modes based on the teachings provided herein.

After the iterative process terminates and advances to step 214 (see FIG. 3A), the m-th iteration representation corresponding to quantum state |ψ_{G}_{ₘ}_{′} [symbol] is taken as the approximated vector state |ψ̅ [symbol] , expressing executable quantum state |Ψ [symbol] of n executable qubits 127. At the same time, unitary operators {W^{(1,m)}, W^{(2,m)}, W^{(3,m)}} for the m-th iteration are translated into the final quantum gate set 122 to be instantiated in quantum mechanical computing device 132.

The process of instantiating quantum gate set 122 involves translation into pulses, considering the parallel nature of the decomposition, of n executable qubits 127 given the quantum hardware used by quantum mechanical computing device 132. Meanwhile, unitary operators {W^{(1,m)},W^{(2,m)},W^{(3,m)}} are transformed into smaller circuits to act on just the affected qubits among n executable qubits 127.

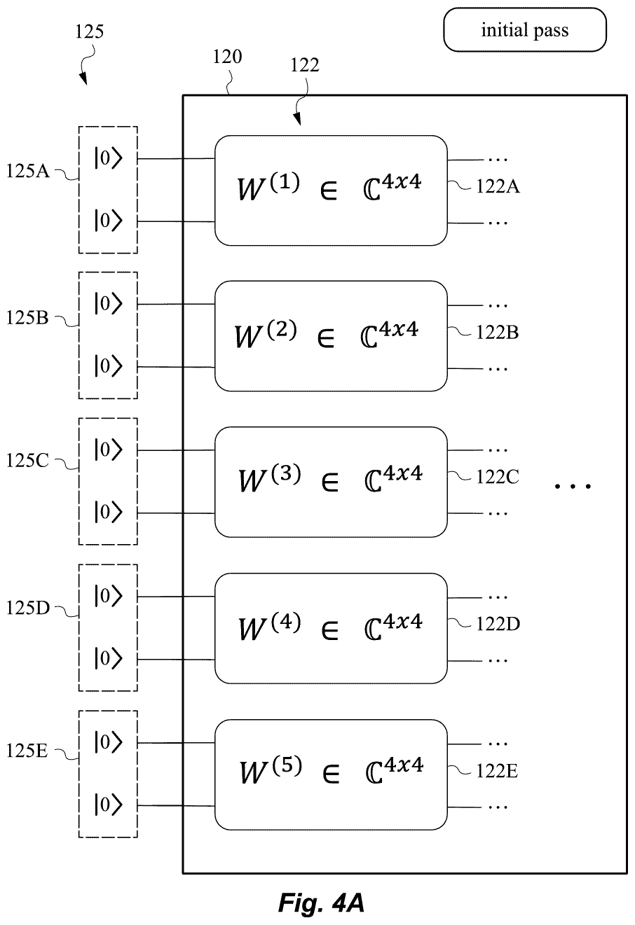

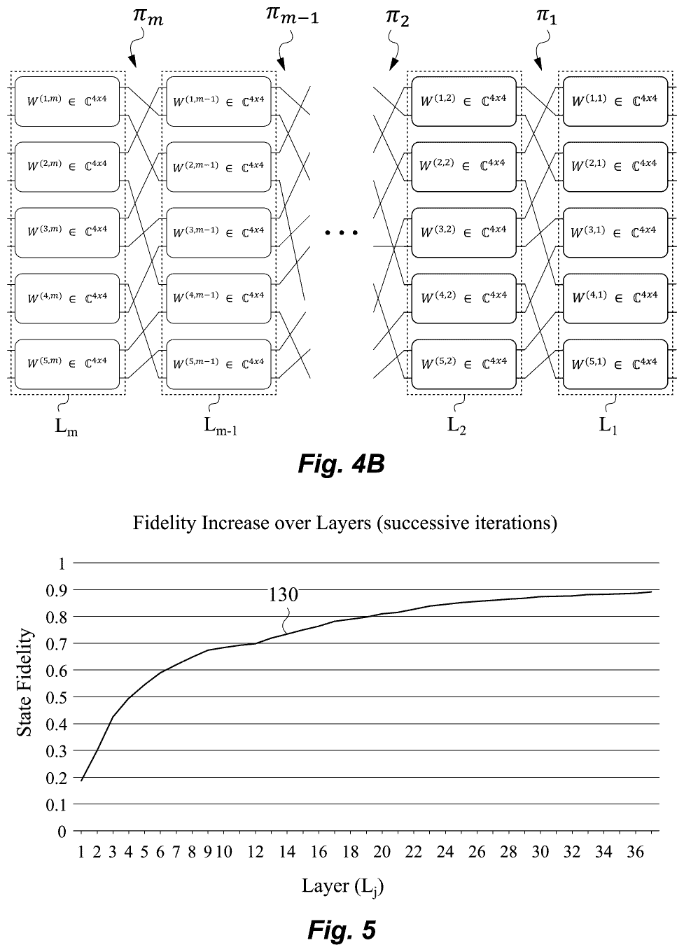

FIG. 4A shows an example of the method of invention applied with a larger list of unitary operators obtained from the Tucker decomposition. Specifically, this example has five unitary operators {W⁽¹⁾,W⁽²⁾,W⁽³⁾,W⁽⁴⁾,W⁽⁵⁾} designed to operate on ten initial qubits 125 (n=10). Advantageously, initial qubits 125 are grouped into five qubit pairs 125A, 125B, . . . , 125E in this example; an approach referred to as 2-qubit layering. Initially, qubit pairs 125A, 125B, 125E are assigned sequentially to the inputs of unitary operators {W⁽¹⁾,W⁽²⁾,W⁽³⁾,W⁽⁴⁾,W⁽⁵⁾}, as shown.

FIG. 4A illustrates the initial or first pass of the method at the point when circuit processor 120 has translated unitary operators {W⁽¹⁾,W⁽²⁾,W⁽³⁾,W⁽⁴⁾,W⁽⁵⁾} into an initial order in quantum gate set 122. By following the 2-qubit layering convention, circuit processor 120 assigns each one of qubit pairs 125A, 125B, . . . , 125E to a corresponding quantum gate 122A, 122B, . . . , 122E belonging to quantum gate set 122. For clarity, each quantum gate 122A, 122B, . . . , 122E is explicitly labeled with the unitary operator that it is tasked with executing on its qubit pair.

Of course, each one of quantum gates 122A, 122B, . . . , 122E is made up of individual lower-level gates (not shown) that together perform the unitary operation defined by the corresponding unitary operator W. These individual lower-level gates are well-known to skilled practitioners and include gates for executing Pauli-Rotations (e.g., Hadamard gates), universal unitary rotations, CNOT, Toffoli gates or their derivatives.

FIG. 4B illustrates the result of m iterations performed on unitary operators {W⁽¹⁾,W⁽²⁾,W⁽³⁾,W⁽⁴⁾,W⁽⁵⁾} from FIG. 4A according to the method of invention. Following the previously introduced convention, the permutation is explicitly indicated in the superscript of the unitary operators in FIG. 4B. Hence, we start from the left with list of unitary operators {W^{(1,1)},W^{(2,1)},W^{(3,1)}, W(4,1), W(5,1)} collectively referred to as a first gating layer L₁. Each iteration reshuffles the connections between unitary operators to produces the next layer, moving from right to left. Thus, permutation π₁ applied to gating layer L₁ produces gating layer L₂ with reshuffled unitary operators {W^{(1,2)},W^{(2,2)},W^{(3,2)},W^{(4,2)},W^{(5,2)}}. The m−1 permutation πₘ₋₁ produces gating layer Lₘ₋₁, and the final m-th permutation πₘ produces unitary operators {W^{(1,m)},W^{(2,m)},W^{(3,m)},W^{(4,m)},W^{(5,m)}}. At this point the condition of decomposition performance measure 118 and state approximation performance measure 130 being within acceptable ranges or above certain thresholds is met and the process advances to final step 214 (see FIG. 3A) of preparing physical state |Ψₒ [symbol] .

FIG. 5 is a plot that illustrates the improvement of state approximation performance measure 130, here state fidelity f as defined above. Specifically, the plot of FIG. 5 shows state approximation measure 130 achieved in successive gating layers Lⱼ (j=1, 2, . . . , m). In the example shown the 36-th gating layer L₃₆ (m=36) achieves state fidelity f=0.891 that is above the threshold set at 0.89 in this case.

The choice of decomposition performance measure 118 and state approximation performance measure 130 is important, since these measures guide the iterative process of finding the desirable Tucker decomposition. In the above embodiment decomposition performance measure 118 was the level of entanglement and state approximation performance measure 130 was fidelity. Alternative embodiments can employ different performance measures such as hardware-efficient quantum operations, which are closely tied to qubit connectivity, particularly in systems where only neighboring qubits can directly interact. The iterative process can be optimized to maximize the use of hardware-efficient operations while minimizing interactions between non-adjacent qubits.

Another alternative embodiment involves limiting the depth of the quantum circuit decomposition, as shallow circuits help reduce noise and errors while enabling scalable quantum computation on near-term hardware. The iterative process of the invention would be correspondingly set to optimize for the best representation within a given depth constraint. It is important to note that this is not an exhaustive list and that multiple performance measures can also be combined to guide the iterative process. Additional alternative performance measures include the time required to create the executable entangled state, the compression level, as well as other suitable loss measures known to those skilled in the art.

Furthermore, the finding operation performed through iteration by tensor processor 112 can deploy various techniques. Preferably, the search for entanglement in multi-partite quantum systems relies on an approximate technique that represents entanglement through a graph structure, as taught above. Each vertex VR of graph GR corresponds to a single qubit or qudit, while the edges ED indicate the degree of correlation between them, measured via mutual information. Crucially, this mutual information is established between the reduced single-qubit or single-qudit mixed states. Given an initial set of n qubits or qudits, most of them are traced out, leaving only a selected pair. The mutual information between the reduced density matrices of the remaining pair is then calculated and assigned to an edge connecting the corresponding vertices in graph GR. This process is repeated for different pairs, progressively constructing a network that encodes the underlying entanglement structure of the system.

For qubits, the mutual information calculation is relatively straightforward due to the simple structure of their 2×2 reduced density matrices, which can often be computed analytically. However, for higher level qudits (d>2), the complexity increases significantly. Since qudits reside in a d-dimensional Hilbert space, their reduced density matrices are d×d, requiring the computation of d>2 eigenvalues instead of just two. The von Neumann entropy, used to quantify mutual information, depends on these eigenvalues, making the calculation for qudits more computationally intensive. Additionally, while qubits exhibit relatively simple entanglement structures, qudits can support a richer variety of quantum correlations, meaning that the mutual information function must capture more complex dependencies. The logarithm base in entropy calculations also differs, with qubits typically using base-2, while for qudits it is often more appropriate to use base-d, reflecting the natural dimensionality of the system.

One possible alternative of the finding operation is to refine the iterative process performed by tensor processor 112. Instead of a uniform search over all possible entanglement structures, the iteration could dynamically adapt by identifying and focusing on the most significant regions of graph GR. Hierarchical clustering techniques could help refine entanglement detection by first identifying densely connected regions in graph GR. Additionally, machine learning could be used to predict which areas of graph GR are most likely to contain non-trivial entanglement patterns, thus optimizing the search and reducing computational overhead. Since the classification of multi-partite entanglement for qudits is more nuanced than for qubits, modification search heuristics deployed by tensor processor 112 would be necessary to account for the increased complexity of qudit entanglement.

Beyond this specific finding operation, the broader problem of identifying entanglement and separability in multi-partite systems remains fundamental to quantum information science. Traditional methods such as entanglement witnesses, entropy-based measures and tensor decomposition techniques face scalability issues when applied to large quantum systems. The graph-based approach described here offers a promising alternative by leveraging mutual information to encode entanglement structure.

Circuit processor 120 can optimize quantum gate set 122 implementations by translating isometry operators into an alternative or second quantum gate set 122′ (not shown) with a lower complexity measure than that required for directly translating any original unitary operator W. Since isometries are a subset of unitary transformations that encode a reduced amount of information, they may allow for more efficient decomposition when using a specialized approach rather than a general-purpose unitary construction. By leveraging this specialized decomposition, circuit processor 120 can minimize computational resources while preserving the integrity of the transformation. The effectiveness of this translation depends on the structure of the isometry and the available hardware-efficient alternative or second quantum gate set 122′, both of which influence the practical feasibility of reducing complexity.

The preferred complexity measures for this optimization include Kolmogorov complexity, which relates to the shortest possible description of a circuit; entangling-gate complexity, which accounts for the number of multi-qubit operations required; and T-gate complexity, which is crucial in fault-tolerant quantum computing as it quantifies the cost of implementing non-Clifford operations. Since T-gates are a limiting resource in error-corrected quantum systems, reducing their count can significantly improve computational efficiency. Circuit processor 120 determines the optimal second quantum gate set 122′ by analyzing the structure of the isometry and selecting a representation that minimizes these complexity measures, ensuring a more efficient quantum computation.

Random Access Memory (RAM) for quantum computers is an often sought after topic, with many patents already created. Most methods from research and subsequent patents consider only broad mechanisms or focus on one single approximation method. If one successfully wants to realize a database, it is necessary to compress the data in such a way that the number of quantum operations is as low as possible. To achieve this optimal compression, one will need a method that considers the natural complexity measure of quantum computing: entanglement. The natural way to describe a state and operations in quantum computing is by using tensors and tensor-operations, also called mode-operators. When encoding real-world data, abstractly stored in vectors, the process of tensorisation is a key step. The method of the present invention searches through many tensorisation configurations, and finds the optimal configuration, such that approximation properties are best. Once the best configuration was found, the decision of lossless or lossy compression is made. From the resulting tensor-decomposition, one can deduce a quantum circuit, as described above, and either transpile it to an optimized quantum circuit, or alternatively, to a series of pulses to be used as voltage time series to run lasers that encode the quantum operations on the physical qubits. The goal of this procedure is to strike a balance between the best representation of data and the shortest time to create the quantum state. Once the calculations are done, these transpiled circuits are sent to a control device, which executes the needed instructions given input commands directly to the operating devices, such as lasers, magnets, SLMs, AOTs, or in general, any kind of device that is used to prepare the quantum system designed for computation of any sort, including but not limited to digital and analog computations.

Since executable qudits are multi-level quantum mechanical objects (i.e., d>2), the quantum computing device must be capable of precisely manipulating and controlling their higher-dimensional states. Unlike qubits, which correspond to d=2 and hence operate in two-level Hilbert space, qudits span a higher d-dimensional space, necessitating hardware that supports multi-level quantum transitions. Suitable platforms include trapped ions, superconducting circuits, neutral atoms and photonic systems, each employing distinct physical mechanisms to implement qudit logic effectively.

Gate operations in qudit-based quantum computing extend beyond those required for qubits. Single-qudit gates generalize Pauli operators, Hadamard transformations and rotation gates to accommodate higher-dimensional states, while multi-qudit gates facilitate entanglement across a broader state space. Two-qudit controlled operations, such as the generalized CNOT and CZ gates, must account for all d levels, while three-qudit gates, such as qutrit Toffoli or Fredkin gates, introduce even more intricate logic. As the number of levels increases, control sequences must be carefully engineered to ensure precise transitions, making gate implementation increasingly complex.

Since the size of the Hilbert space scales exponentially with qudit dimension (d), qudit-based computation enables higher information density per quantum resource. Certain quantum algorithms, such as the quantum Fourier transform, can leverage qudits to reduce circuit depth, leading to lower overall error rates. Additionally, higher-dimensional entanglement structures open new possibilities for quantum error correction and quantum simulations. While qubits require only two-level gates, qudits necessitate a more sophisticated control framework but offer the potential for greater computational efficiency.

Despite their advantages, qudits are not yet widely adopted in quantum computing due to practical challenges in hardware design, error control and scalability. The primary reason is technological maturity. Most quantum computing architectures were developed around qubits, and significant engineering efforts have refined qubit-based systems. Superconducting circuits, trapped ions and other qubit-based platforms have well-established techniques for initialization, control and readout, whereas qudit systems demand additional complexity in control electronics and calibration.

Gate fidelity and control precision further limit qudit adoption. Qubit-based gates achieve high fidelity using microwave pulses or laser-driven transitions, whereas multi-level qudit transitions require more precise pulse shaping and frequency selectivity. This added complexity can lead to higher error rates, diminishing the theoretical advantages of qudits. Additionally, while qudits can reduce the number of required physical quantum systems for specific tasks, increased gate complexity and potential crosstalk between levels make scaling large qudit-based systems more challenging. Nevertheless, it will be noted that the present invention applies to both qubit- and qudit-systems to leverage their respective strengths and advantages.

It will be evident to a person skilled in the art that the present invention admits of still other embodiments and variants. Therefore, its scope should be judged by the claims and their legal equivalents.

1. A system for encoding classical data into an executable quantum state having n executable qudits, said system comprising:
a) a non-transitory storage medium for holding said classical data;
b) an initial quantum circuit with n initial qudits in a predetermined initial state;
c) a loading device coupled to said non-transitory storage medium for receiving and loading said classical data onto said n executable qudits, said loading device comprising:
1) an input/output processor for initializing said classical data to obtain initialized data representing said n executable qudits and storing said initialized data in said non-transitory storage medium;
2) a tensor processor for finding a first representation of said initialized data by a tensorized configuration having a non-unique decomposition comprising a tensor G and unitary operators, wherein said tensor processor obtains a list of said unitary operators that minimizes a decomposition performance measure of said tensor G;
3) a circuit processor for translating said list of unitary operators into a quantum gate set and for applying said quantum gate set to said initial quantum circuit with n initial qudits to obtain a prepared quantum circuit in said executable quantum state having said n executable qudits;
4) a quantum circuit executor for obtaining a state approximation performance measure of said executable quantum state;
wherein said tensor processor finds a second representation of said initialized data stored in said non-transitory storage medium when said decomposition performance measure and said state approximation performance measure are above predetermined thresholds.

2. The system of claim 1, wherein said classical data is an N-dimensional complex-valued vector.

3. The system of claim 1, wherein said initialized data is in the form of dⁿ-dimensional complex-valued and normalized data vector.

4. The system of claim 1, wherein said tensor G and said unitary operators are members of the Tucker decomposition, and wherein said tensor G is a core-tensor.

5. The system of claim 1, wherein said tensor processor reduces said first representation of said initialized data to a low-rank tensor, said low-rank tensor being selected from low-rank approximations and low-rank representations.

6. The system of claim 1, further comprising a quantum mechanical computing device for receiving control-sequences of said prepared quantum circuit and executing said n executable qudits.

7. The system of claim 6, wherein said n executable qudits comprise multi-level quantum-mechanical objects that are manipulated by said control-sequences.

8. The system of claim 6, wherein said quantum mechanical computing device is selected from the group of devices having mechanisms selected from among lasers, magnets, optics and electronics as receivers of said control-sequences.

9. The system of claim 1, wherein said decomposition performance measure and said state approximation performance measure are selected from the group consisting of fidelity, level of entanglement, time for creating said executable quantum state, compression level and a loss measure.

10. The system of claim 1, wherein said tensor processor performs said finding using a search method comprising iteration of communities of vertices of a graph, in which said graph has edges that have weights assigned by said initialized data representing said n executable qudits.

11. The system of claim 10, wherein said weights are based on the mutual information between qudits belonging to said n executable qudits.

12. The system of claim 1, wherein said list of said unitary operators comprises core-tensors which exhibit decreasing geometric entanglement in said second representation when said core-tensors are interpreted as vectors.

13. The system of claim 1, wherein said n initial qudits are n initial qubits.

14. The system of claim 1, wherein said unitary operators of said first representation with said reduction to said low-rank tensor are of the group of isometry operators.

15. The system of claim 14, wherein said circuit processor translates said isometry operators to a second quantum gate set having a lower complexity measure than said quantum gate set.

16. The system of claim 15, wherein said complexity measure is selected from the group consisting of Kolmogorov, entangling-gate or T-gate complexity.

17. The system of claim 1, wherein said quantum gate set is selected from the group of quantum gates comprised of single-qudit rotations and multi-qudit entangling gates.

18. The system of claim 17, wherein said group of quantum gates are further selected from the group of Pauli-Rotations, universal unitary rotations, CNOT, Toffoli gates or their derivatives.

19. A method for encoding classical data into an executable quantum state having n executable qudits, said method comprising:
a) holding said classical data in a non-transitory storage medium;
b) preparing an initial quantum circuit with n initial qudits in a predetermined initial state;
c) receiving said classical data from said non-transitory storage medium in a loading device coupled to said non-transitory storage medium, said loading device further loading said classical data onto said n executable qudits by:
1) initializing said classical data to obtain initialized data representing said n executable qudits and storing said initialized data in said non-transitory storage medium;
2) finding a first representation of said initialized data by a tensorized configuration having a non-unique decomposition comprising a tensor G and unitary operators, wherein said first representation comprises a list of said unitary operators that minimizes a decomposition performance measure of said tensor G;
3) translating said list of unitary operators into a quantum gate set and applying said quantum gate set to said initial quantum circuit with n initial qudits to obtain a prepared quantum circuit in said executable quantum state having said n executable qudits;
4) obtaining a state approximation performance measure of said executable quantum state;
wherein a second representation of said initialized data stored in said non-transitory storage medium is found when said decomposition performance measure and said state approximation performance measure are above predetermined thresholds.

20. The method of claim 19, wherein said initializing is performed by an input/output processor, said finding is performed by a tensor processor said translating is performed by a circuit processor and said obtaining is performed by a quantum circuit processor.
